(19) United States
(12) Patent Application Publication
(10) Pub. No.: US 2004/0106016 A1
(43) Pub. Date: Jun. 3, 2004

(54) Coated cutting tool

(76) Inventors: Yoshio Okada, Itami-shi (JP); Minoru Itoh, Itami-shi (JP); Hideki Moriguchi, Itami-shi (JP)

Correspondence Address: MCDERMOTT WILL & EMERY, 600 13TH STREET, N.W., WASHINGTON, DC, 20005-3096, US

(21) Appl. No.: 10/669,630

(22) Filed: Sep. 25, 2003

(30) Foreign Application Priority Data
Sep. 27, 2002 (JP) 284413/2002

(51) Int. Cl. B32B 9/00

(52) U.S. Cl. 428/698; 407/119

(57) ABSTRACT

A coated cutting tool having a long tool life because of its excellent wear resistance even under the working condition that the cutting part is subjected to high temperatures resulting from high-speed, high-efficiency machining. The coated cutting tool has a coating formed over the hard-alloy substrate. The coating comprises a first compound layer made of oxycarbonitride of a metal belonging to the IVa, Va, or VIa group in the periodic table. The first compound layer has: (a) atomic ratios of carbon (x), nitrogen (y), and oxygen (z) that satisfy x>y>z; x+y+z=1; 0.74>x>0.35; 0.45>y>0.20; and 0.30>z>0.06; (b) an average layer thickness of 0.5 to 20 μm that constitutes at least one-half the average total thickness of the coating; (c) a columnar structure; and (d) in the X-ray diffraction analysis, the highest peak intensity lying at one of the (220), (311), and (422) planes.

### BACKGROUND OF THE INVENTION

1. Field of the Invention

The present invention relates to a coated cutting tool having a coating over its substrate, particularly a coated cutting tool capable of having increased tool life because of its excellent wear resistance even under the working condition that the cutting part is subjected to high temperatures resulting from high-speed, high-efficiency machining.

2. Description of the Background Art

Continuous cutting and interrupted cutting of various materials such as steel and cast iron have been performed with a coated cemented-carbide cutting tool or a coated cermet-alloy cutting tool, which has a coating having an average thickness of 3 to 20 μm formed over its substrate made of cemented carbide or cermet alloy by using the chemical vapor deposition (CVD) method or the physical vapor deposition (PVD) method. Usually, the cemented carbide is based on tungsten carbide (hereinafter referred to as WC), and the cermet alloy is based on titanium carbonitride (hereinafter referred to as TiCN). Usually, the coating is composed of an inner layer made of at least one titanium compound selected from titanium carbide (hereinafter referred to as TiC), titanium nitride (hereinafter referred to as TiN), TiCN, titanium oxycarbide (hereinafter referred to as TiCO), and titanium oxycarbonitride (hereinafter referred to as TiCNO) and an outer layer made of aluminum oxide (hereinafter referred to as Al₂O₃).

Patent document 1 shown below has proposed that the TiCN layer be produced by using organic carbonitride as the reaction gas in an ordinary CVD apparatus at moderate temperature so that the TiCN layer can have a columnar structure in order to improve the wear resistance.

Patent document 2 shown below has proposed that the TiCNO layer be produced by using TiCl₄, CH₃CN, CO, N₂, and H₂ gases so that the TiCNO layer can have the highest peak intensity at the (111) plane in the X-ray diffraction analysis and have atomic ratios shown in TiCᵤNᵥO_{w} satisfying u≧v>w>0 and u+v+w=1 and 0.05≧w>0 in order to improve the performance in interrupted cutting.

Patent document 3 shown below has proposed that the TiCNO layer be produced such that the TiCNO layer has the highest peak intensity at the (422) or (311) plane in the X-ray diffraction analysis and has an oxygen content of 0.05 to 3 wt. %.

Patent document 4 shown below has proposed that the TiCNO layer be produced such that the TiCNO layer has atomic ratios shown in TiCₓO_{y}N_{z} satisfying 0.7≦x+y+z≦1.3 and 0.4<y<0.6.

Patent document 5 shown below has proposed that the TiCNO layer be produced such that the TiCNO layer contains oxygen diffused from a layer immediately underneath made of TiOᵥ, where v is an atomic ratio of “O” to “Ti” and lies in the range of 1.2 to 1.7, and has atomic ratios shown in TiCₓN_{y}(O_{z}) satisfying x+y+z=1 and 0.25≦x≦0.65 and 0.25≦y≦0.65 and 0.01≦z≦0.4

(Patent document 1): published Japanese patent 2974284

(Patent document 2): published Japanese patent application Tokukaihei 8-257808

(Patent document 3): published Japanese patent application Tokukai 2000-158209

(Patent document 4): published Japanese patent application Tokukaihei 8-47999

(Patent document 5): published Japanese patent application Tokukai 2001-71203

The cutting operation has a tendency to increase the speed because of the improvement of the performance and increase in output of cutting machines in addition to the consideration of labor and energy saving in cutting operation in recent years. Furthermore, the environment protection issues have promoted dry machining, which does not use cutting fluid. As a result, the cutting part of the cutting tool is subjected to a temperature as high as about 1,000° C. at the time of machining. The above-described coated cutting tools are intended to improve the mechanical strength, bonding strength, and lubricity at the time of interrupted cutting particularly by coating the tool with the TiCNO layer. However, the above-described shift in the machining method makes it difficult to suppress the wear of the tool in the conventional coated cutting tools. As a result, the tool reaches the end of its useful life in comparatively short time.

More specifically, in the technique proposed by Patent document 2, the TiCNO layer contains an extremely small amount of oxygen as shown by 0.05≧w>0. Consequently, the TiCNO layer cannot work with excellent cutting performance supported by sufficient wear and breakage resistance under the working condition that the cutting part is subjected to high temperatures resulting from high-speed, high-efficiency machining.

In the technique proposed by Patent document 3, the TiCNO layer contains an extremely small amount of oxygen. When the atomic ratio of the oxygen to the oxycarbonitride is calculated by using the weight percentage of the oxygen, the atomic ratio lies in the range of 0.001 to 0.06. This amount is comparable to that specified in Patent document 2. (Patent document 3 does not dearly state the contents (atomic ratios) of carbon and nitrogen.) As a result, the TiCNO layer reaches the end of its useful life in comparatively short time in high-speed, high-efficiency machining as in Patent document 2.

In the technique proposed by Patent document 4, the TiCNO layer is intended to function as a bonding layer between the layer directly beneath (the first layer) and the layer directly above (the third layer) and to function as a layer for preventing the diffusion of cobalt from the substrate to the coating. Consequently, the TiCNO layer is thinner than the third layer. The thin and oxygen-rich TiCNO layer cannot be expected to have improved wear resistance, in particular, in the present-day technology.

In the technique proposed by Patent document 5, the TiCNO layer has a thickness of 0.05 to 2 μm, which is relatively thin. In addition, the layer is formed by using diffused oxygen to attain lubricity. As a result, it is difficult to improve the wear resistance.

### SUMMARY OF THE INVENTION

The principal object of the present invention is to offer a coated cutting tool having long tool life because of its excellent wear resistance even under the working condition that the cutting part is subjected to high temperatures resulting from high-speed, high-efficiency machining.

The present invention achieves the foregoing object by specifying the following properties of the TiCNO layer: the atomic ratios of carbon, nitrogen, and oxygen; the thickness; the constituting percentage in the entire coating; the crystal structure; and the highest peak intensity in the X-ray diffraction analysis.

According to the present invention, the coated cutting tool has a coating formed over its hard-alloy substrate. The coating comprises a first compound layer that comprises at least one layer and that has an average layer thickness of at least 0.5 μm and at most 20 μm. The thickness constitutes at least one-half the average total thickness of the coating. The at least one layer is made of oxycarbonitride of a metal belonging to the IVa, Va, or VIa group in the periodic table. The at least one layer has:

(a) atomic ratios of carbon, nitrogen, and oxygen, expressed as x, y, and z, respectively, that satisfy the following formulae:

x>y>z and x+y+z=1

0.74>x>0.35, 0.45>y>0.20, and 0.30>z>0.06;

(b) a columnar structure; and

(c) in the crystal structure, the largest orientational texture coefficient that lies in one of the orientational texture coefficients TC(220), TC(311), and TC(422) at the (220), (311), and (422) planes, respectively.

The present inventors intensively studied to develop a coated cutting tool having excellent cutting performance and an increased tool life even w,hen it i used for high-speed, high-efficiency continuous or interrupted cutting with the consideration of environment protection. The study was focused particularly on the wear resistance of the coating. Then, the present inventors obtained the following findings. When a layer made of oxycarbonitride of a metal belonging to the IVa, Va, or VIa group in the periodic table, including the well-known TiCNO, is produced by specifying the following conditions as described above, the wear resistance can be improved over the conventional TiCNO layer even under the cutting condition that the cutting part is subjected to higher temperatures:

(1) the atomic ratios of carbon (x), nitrogen (y), and oxygen (z);

(2) the items (b) and (c) above; and

(3) the average layer thickness.

As a result, the tool life can be further increased. The specification of the present invention is based on the above-described findings. The present invention is explained in further detail below.

In the present invention, the atomic ratios of carbon (x), nitrogen (y), and oxygen (z) in the first compound layer are specified as x>y>z and x+y+z=1. If the ratios do not satisfy the specification, the atomic structure in the layer tends to distort, making it difficult to improve the wear resistance in the intended high-speed, high-efficiency machining.

The atomic ratios are also required to satisfy the limitations of 0.74>x>0.35, 0.45>y>0.20, and 0.30>z>0.06. If the atomic ratio of carbon is not less than 0.74 or the atomic ratio of nitrogen is not more than 0.20, the hardness of the layer increases. The hardness increase decreases the toughness, thereby increasing the possibility of the occurrence of fracture. As a result, the tool life is decreased. On the other hand, if the atomic ratio of carbon is not more than 0.35 or the atomic ratio of nitrogen is not less than 0.45, the layer wears away at a notably high rate, decreasing the tool life. If the atomic ratio of oxygen is not less than 0.30, the atomic structure distorts significantly, so that the layer tends to be brittle. On the other hand, if the atomic ratio of oxygen is not more than 0.06, the intended wear resistance cannot be achieved under the working condition that the cutting part is subjected to high temperatures. In particular, when the atomic ratios satisfy the limitations of 0.62>x>0.40, 0.40>y>0.25, and 0.20>z>0.13, the wear resistance can be further improved.

In order to attain the atomic ratios of carbon (x), nitrogen (y), and oxygen (z) within the foregoing specified limits and to prevent the atomic structure from distorting, it is recommendable to produce the first compound layer by the following process. First, the following gases are used as the material gas: vaporized liquid organic carbonitride such as CH₃CN, chloride of a metal belonging to the IVa, Va, or VIa group in the periodic table such as VCl₄, ZrCl₄, and TiCl₄, hydrogen, and nitrogen. Other gases such as Ar, CO, and CO₂ may also be used as required. Next, H₂O is added to the material gas such that the volume ratio of the H₂O to the liquid organic carbonitride becomes at least 0.01 and at most 5.00. As described above, H₂O may be added to the organic carbonitride to use the organic carbonitride as the source of H₂O. H₂O may also be added to one of the other gases listed above to use the gas as the source of H₂O. Even when H₂O is added to another gas, the volume ratio of H₂O to the organic carbonitride is controlled to become at least 0.01 and at most 5.00. In addition to the volume control of H₂O, the temperature of the reaction atmosphere is controlled to be at least 700° C. and at most 1,000° C., and the pressure of the reaction atmosphere is controlled to be at least 5 kPa and at most 20 kPa. When the volume ratio of H₂O and the temperature and pressure of the reaction atmosphere are controlled to fall within the specified limits, the atomic ratios of carbon, nitrogen, and oxygen in the first compound layer can fall within the foregoing specified limits. It is recommendable to form the first compound layer by using the conventional CVD or PVD apparatus.

The atomic ratios may be measured with a well-known method such as the X-ray photoelectron spectroscopy, secondary ion mass spectrometry, or Auger electron spectroscopy. In the present invention, nonmetallic elements, such as chlorine, not more than 0.5 atomic % are treated as impurities in the measurement.

As described above, the present inventors found that when a proper amount of oxygen is added to the first compound layer by the above-described method, the wear resistance can be improved over the conventional coated cutting tool even under harsher cutting conditions and environments. Accordingly, the present invention first specifies the atomic ratios in the first compound layer as described above. The present inventors also found that the wear resistance can be further improved when the first compound layer made of the foregoing oxycarbonitride satisfies the following conditions:

(a) The layer has an average layer thickness of at least 0.5 μm and at most 20 μm.

(b) The thickness constitutes at least one-half the average total thickness of the coating (constituting ratio: at least 0.5).

(c) The layer has a columnar structure.

Accordingly, the present invention specifies the layer thickness, constituting ratio, and crystal structure as described above.

In the present invention, when the first compound layer comprises two or more layers, whether the layers have the same atomic ratios or different ones, the term “average layer thickness” means the sum of the thicknesses of these layers. If the average layer thickness is less than 0.5 μm, the wear resistance cannot be improved under high-temperature cutting conditions. On the other hand, if the average layer thickness is more than 20 μm, although the increased thickness improves the wear resistance, the breakage resistance cannot be improved. As a result, the tool life is decreased. In addition, if the average layer thickness is less than one-half the average total thickness of the coating (constituting ratio of the first compound layer: less than 0.5) or the first compound layer has a granular structure, the intended improvement of the wear resistance cannot be achieved.

To form a columnar structure in the first compound layer, it is recommendable that the material gas comprise organic carbonitride, such as CH₃CN, which facilitates the formation of the columnar structure. In addition, as described above when the temperature of the reaction atmosphere is controlled to be at least 700° C. and at most 1,000° C., and the pressure of the reaction atmosphere is controlled to be at least 5 kPa and at most 20 kPa, the columnar structure can be formed in the first compound layer. When a gas other than the organic carbonitride is used, it is recommendable to increase the film-forming speed, to raise the film-forming temperature, or to increase the concentration of the material gas.

Furthermore, the present inventors found that when the first compound layer made of the foregoing oxycarbonitride has a specific crystal orientation, not only the wear resistance but also the mechanical strength of the layer can be improved even under harsh cutting conditions that the cutting part is subjected to high temperatures. Accordingly, the present invention specifies the crystal orientation. More specifically, the crystal of the first compound layer is required to have the maximum value of the orientational texture coefficient TC (coefficient of texture orientation intensity) that lies in one of the crystal growth orientations of the (220), (311), and (422) planes out of the (111), (200), (220), (311), (331), (420), (422), and (511) planes. The orientational texture coefficient TC is defined as Eq. 1 below.

$$TC ( hkl ) = \frac{I ( hkl )}{{I}_{0} ( hkl )} {\{ \frac{1}{8} {\sum }^{} \frac{I ( hkl )}{{I}_{0} ( hkl )} \}}^{- 1} , \qquad Equation 1$$

where I(hkl): the measured diffraction intensity at the (hkl) plane,

Iₒ(hkl): the average value of the powder diffraction intensities of the carbide and nitride of the metal constituting the (hkl) plane, in accordance with the JCPDS file, and

(hkl): the following eight planes: (111), (200), (220), (311), (331), (420), (422), and (511) planes.

In the above expression, “JCPDS” is the abbreviation of “Joint Committee on Powder Diffraction Standard,” and “JCPDS file” means “Powder Diffraction File Published by JCPDS International Center for Diffraction Data.”

To allocate the maximum value at one of the orientational texture coefficients of the (220), (311), and (422) planes in the crystal growth orientation, it is recommendable to properly control the conditions for forming the first compound layer, such as the temperature and pressure for film formation, gas composition, gas-flow velocity, and gas-flow rate. Another method to be recommended is to properly control the surface condition of the member directly beneath the first compound layer, whether it is the substrate or another compound layer. More specifically, for example, over the substrate that is controlled to have a surface roughness of at least 0.05 μm and at most 1.5 μm, the first compound layer may be formed by properly controlling the film-forming conditions. As another example, over another compound layer that is controlled to have a proper surface roughness, chemical condition of the crystal grains, and grain size, the first compound layer may be formed by properly controlling the film-forming conditions.

It is recommendable to measure the diffraction intensity at a flat portion of the substrate to avoid the reflection of X-rays by the uneven surface of the substrate. The JCPDS file has no data Of the X-ray diffraction intensities on oxycarbonitride of the metals belonging to the IVa, Va, and VIa groups in the periodic table. However, the identification of the oxycarbonitride in the first compound layer by the diffraction intensity can be performed by the following method. First, the measured diffraction data of the oxycarbonitride of the metal belonging to the IVa, Va, or VIa group in the periodic table are compared with the file's diffraction data of the carbide and nitride of the metal belonging to the IVa, Va, or VIa group in the periodic table. This comparison enables the estimation of individual Miller indexes. Finally, the diffraction intensity at each Miller index can be read.

The metal belonging to the IVa, Va, or VIa group in the periodic table to be used for the first compound layer is not limited to one type. To the main metal element, another metal element may be added as a subelement. In this case, it is desirable that the atomic ratio of the subelement to the main element be at most 40%. For example, (Ti₇₀W₃₀)CNO may be employed, where the numerals denote the atomic ratios.

In order to further increase the wear resistance to increase the tool life, it is desirable that the first compound layer have a columnar structure having an aspect ratio of at least three. If the aspect ratio is less than three, the wear resistance tends to decrease under the high-temperature cutting condition. It is also desirable that the first compound layer have a crystal structure in which the crystal has an average grain diameter of at least 0.05 μm and at most 1.5 μm. If the average grain diameter is less than 0.05 μm, the first compound layer cannot have high crystallinity. As a result, the bonding strength between the crystal grains constituting the layer becomes low, so that the layer has difficulty in maintaining its form. Consequently, the layer cannot have enough wear resistance. On the other hand, if the average grain diameter is more than 1.5 μm, the surface unevenness of the first compound layer becomes excessive. As a result, the frictional resistance with the workpiece increases, increasing the possibility of the occurrence of abnormally high cutting temperatures. Consequently, the layer cannot have excellent wear resistance.

In order to achieve the specified aspect ratio and crystal-grain diameter, it is recommendable to grow a columnar structure while maintaining a small average grain diameter as a basic method. More specifically, it is recommendable to properly control the conditions for forming the first compound layer, such as the temperature and pressure for film formation, gas composition, gas-flow velocity, and gas-flow rate. Another method to be recommended is to properly control the surface condition of the member directly beneath the first compound layer, whether it is the substrate or another compound layer. More specifically, for example, over the substrate that is controlled to have a surface roughness of at least 0.05 μm and at most 1.5 μm, the first compound layer may be formed by properly controlling the film-forming conditions. As another example, over another compound layer that is controlled to have a proper surface roughness, chemical condition of the crystal grains, and grain size (particularly at least 0.01 μm and at most 1.0 μm), the first compound layer may be formed by properly controlling the film-forming conditions.

The aspect ratio can be measured by the following method, for example. First, a perpendicularly cut surface of the coating is mirror-finished. Then, the surface is etched to clarify the grain boundaries of the columnar structure in the first compound layer. The width of each crystal is measured at the thicknesswise center of the or each layer of the first compound layer in a direction parallel to the surface of the substrate. The width is assumed to be the diameter of the crystal grain. The measured results of individual crystal grains are averaged to obtain the average crystal-grain diameter. The thickness of the layer is divided by the average crystal-grain diameter to obtain the aspect ratio.

As described above, the coating comprises a first compound layer that comprises at least one layer. The coating, however, may comprise in addition to the first compound layer a second compound layer comprising at least one layer composed of a material selected from the group consisting of (a) carbide, nitride, carbonitride, boride, boronitride, borocarbonitride, oxyboronitride, oxide, oxycarbide, oxynitride, and oxycarbonitride of the metals belonging to the IVa, Va, and VIa groups in the periodic table; (b) aluminum oxide; and (c) a solid solution of these. In the above group, the oxycarbonitride having the same atomic ratios as those of the first compound layer is excluded. In this case, it is desirable that the coating comprising the first and second compound layers have an average total thickness of at least 1.0 μm and at most 30.0 μm. This structure enables further improvement of the wear resistance. If the average total thickness is less than 1.0 μm, the wear resistance cannot be effectively improved. On the other hand, if the average total thickness is more than 30.0 μm, although the increased thickness improves the wear resistance, the hardness is increased. The increased hardness reduces the breakage resistance. As a result, the tool life tends to be decreased. The oxycarbonitride layer constituting the second compound layer mainly has a granular structure.

In the present invention, the coating may comprise the following members:

(a) a titanium nitride layer formed as the innermost layer over the surface of the hard-alloy substrate;

(b) the first compound layer comprising at least two layers formed at the outside of the titanium nitride layer; and

(c) the second compound layer comprising at least one layer formed at the outside of the first compound layer.

Titanium nitride can bond to the hard-alloy substrate with high strength. Therefore, it is desirable to use it as the innermost layer. The coating having the foregoing structure can have improved wear resistance even under harsher cutting conditions and environments. Consequently, the coating can have an increased useful life. In the above-described coating structure, the first compound layer may be formed either immediately over the titanium nitride layer or through another compound layer. Similarly, the second compound layer may be formed either immediately over the first compound layer or through another compound layer.

In the present invention, the coating may further comprise the following members:

(a) a titanium compound layer that:

(a1) comprises at least one layer made of a material selected from the group consisting of titanium boronitride and titanium oxyboronitride; and

(a2) is formed immediately over the first compound layer;

(b) an oxide layer that:

(b1) comprises at least one layer made of a material selected from the group consisting of aluminum oxide, zirconium oxide, and a solid solution of these; and

(b2) is formed immediately over the titanium compound layer; and

(c) a compound layer that:

(c1) is made of a material selected from the group consisting of carbide, nitride, carbonitride, oxycarbide, oxynitride, and oxycarbonitride (except the oxycarbonitride having the same atomic ratios as those of the first compound layer) of the metals belonging to the IVa, Va, and VIa groups in the periodic table; and

(c2) is formed at the outermost position of the coating.

The titanium compound layer is provided immediately over the first compound layer to improve the bonding strength between the first compound layer and the oxide layer. The oxide layer is provided immediately over the titanium compound layer to improve the chemical stability of the layers underneath because it can suppress the oxidation of the layers and has excellent thermal stability. The outermost compound layer is provided to identify the used corner, to dress the cutting tool, and to exploit its good chemical stability. It may be made of a material such as TiN, TiCN, ZrC, HfC, and HfN. In particular, a TiN layer not only has low reactivity with the workpiece made of a material such as iron and superior adhesion resistance but also functions as a gold-tinted layer, which facilitates the identification of the used corner of the cutting tool. The coating having the above-described structure can reinforce the bonding strength between the layers. As a result, the coating can have not only improved wear resistance but also improved spalling resistance even under harsher cutting conditions and environments. Consequently, the coating can have an increased useful life.

The above-described second compound layer, titanium nitride layer, titanium compound layer, oxide layer, and outermost compound layer may be formed by the well-known CVD or PVD method. The method includes the hot-filament CVD method, plasma CVD method, reaction magnetron sputtering method, and ion-plating method.

In the present invention, the hard-alloy substrate may be made of well-known hard alloy, such as cemented carbide based on tungsten carbide, cermet alloy, ceramic, cBN, and other alloys for cutting use. As with the conventional cutting tool, the cutting-edge portion of the coated cutting tool of the present invention may be surface-treated by a polishing or laser treatment after the above-described coating is formed over the surface of the substrate. The surface treatment can be performed without a noticeable deleterious effect on the properties of the coating.

As explained above, the present invention is particularly effective in offering a coated cutting tool having excellent wear resistance even under the working condition that the cutting part is subjected to high temperatures resulting from high-speed, high-efficiency machining. As a result, the coated cutting tool can have a further increased tool life.

### DETAILED DESCRIPTION OF THE INVENTION

Embodiments of the present invention are explained below.

### EXAMPLE 1

The hard-alloy substrate was produced by the following process. First, the following material powders were prepared with the indicated weight percentage: 87% WC, 1% TiC, 3% NbC, 1% ZrC, and 8% Co. The powders were wet-mixed with a ball mill for 72 hours. The mixed powders were dried and formed with a press into a green compact. The green compact had the shape of an indexable insert with chip breakers expressed as ISO SNMG120408. The green compact was placed in a sintering furnace to besintered at 1,400° C. in an atmosphere under vacuum for two hours. The sintered body was subjected to a honing treatment to obtain the cemented-carbide substrate. Over the obtained substrate, various types of first compound layers made of oxycarbonitride of metals belonging to the IVa, Va, and VIa groups in the periodic table were formed by using a CVD apparatus under the conditions shown in Table I. In Table I, the title of the column “amount of H₂O” means the volume ratio of H₂O to CH₃CN. Table II shows the forming conditions for other compound layers than the first compound layer. Various samples were produced as shown in Table III. Table III shows the constitution of the coating, average thickness of each layer, average total thickness of the coating (shortened as “total thickness”), ratio of the average layer thickness of the first compound layer to the average total thickness of the coating (shortened as “constituting ratio), aspect ratio, average diameter of the crystal grains (shortened as “grain diameter”), and plane at which the maximum orientational tissue coefficient of the first compound layer lies (shortened as “plane of max. TC”). In Table III, the symbols “a” to “l” show the types of first compound layers shown in Table I.

TABLE I

| First | | Composition of reaction gas | | Reaction atmosphere | |
|---|---|---|---|---|---|
| compound layer | | | Amount of | Temperature | Pressure |
| Type | Composition | volume % | H₂O^{(*)} | (° C.) | (kPa) |
| a | Ti(C_{0.68}N_{0.25}O_{0.07}) | TiCl₄: 2%, CH₃CN: 2.0%, N₂: 20%, Ar: 2%, H₂: remainder | 0.130 | 900 | 6.7 |
| b | Ti(C_{0.49}N_{0.35}O_{0.16}) | TiCl₄: 2%, CH₃CN: 1.5%, N₂: 20%, Ar: 2%, H₂: remainder | 0.500 | 900 | 6.7 |
| c | Ti(C_{0.38}N_{0.33}O_{0.29}) | TiCl₄: 2%, CH₃CN: 0.9%, N₂: 15%, CO: 1%, H₂: remainder | 1.500 | 800 | 13.3 |
| d | Ti(C_{0.57}N_{0.40}O_{0.03}) | TiCl₄: 2%, CH₃CN: 1.2%, N₂: 30%, Ar: 1%, H₂: remainder | 0.001 | 950 | 80 |
| e | Ti(C_{0.29}N_{0.33}O_{0.38}) | TiCl₄: 2%, CH₃CN: 0.7%, N₂: 30%, CO: 4%, H₂: remainder | 0.001 | 1,000 | 80 |
| f | Ti(C_{0.40}N_{0.40}O_{0.20}) | TiCl₄: 2%, CH₃CN: 1.0%, N₂: 30%, Ar: 1%, H₂: remainder | 0.001 | 980 | 80 |
| g | Ti(C_{0.34}N_{0.33}O_{0.33}) | TiCl₄: 2%, CH₃CN: 0.3%, N₂: 40%, Ar: 1%, H₂: remainder | 9.500 | 1,000 | 80 |
| h | Zr(C_{0.50}N_{0.30}O_{0.20}) | ZrCl₄: 2%, CH₃CN: 5.0%, N₂: 30%, Ar: 3%, H₂: remainder | 4.100 | 980 | 20 |
| i | Zr(C_{0.80}N_{0.13}O_{0.07}) | ZrCl₄: 2%, CH₃CN: 9.5%, N₂: 5%, Ar: 2%, H₂: remainder | 0.008 | 1,050 | 4 |
| j | TiZr(C_{0.50}N_{0.30}O_{0.20}) | TiCl₄: 1%, ZrCl₄: 0.6%, CH₃CN: 4.3%, N₂: 25%, , H₂: remainder | 3.500 | 980 | 20 |
| k | V(C_{0.50}N_{0.30}O_{0.20}) | VCl₄: 2%, CH₃CN: 5.0%, N₂: 30%, Ar: 2%, H₂: remainder | 4.000 | 800 | 15 |
| l | V(C_{0.30}N_{0.42}O_{0.28}) | VCl₄: 2%, CH₃CN: 0.5%, N₂: 50%, Ar: 2%, H₂: remainder | 9.800 | 800 | 15 |

(*): Volume percent of H₂O to CH₃CN

TABLE II

| | | Reaction atmosphere | |
|---|---|---|---|
| Composition | Composition of reaction gas | Temperature | Pressure |
| of coating | (volume %) | (° C.) | (kPa) |
| TiN | TiCl₄: 4%, N₂: 35%, H₂: remainder | 900 | 30 |
| Granular | TiCl₄: 4%, CH₄: 4%, N₂: 20%, H₂: remainder | 1,020 | 14 |
| TiCN | | | |
| Columnar | TiCl₄: 4%, CH₃CN: 0.6%, N₂: 20%, H₂: remainder | 800 | 7 |
| TiCN | | | |
| TiC | TiCl₄: 4%, CH₄: 8%, Ar: 20%, H₂: remainder | 1,020 | 7 |
| TiCO | TiCl₄: 4%, CO: 4%, H₂: remainder | 1,020 | 7 |
| Granular | TiCl₄: 4%, CO: 3%, CH₄: 3%, N₂: 20%, H₂: remainder | 1,020 | 14 |
| TiCNO | | | |
| TiBN | TiCl₄: 4%, BCl₃: 5%, N₂: 5%, H₂: remainder | 1,020 | 30 |
| κ-type Al₂O₃ | AlCl₃: 2%, CO₂: 5%, HCl: 2%, H₂S: 0.3%, H₂: remainder | 950 | 7 |
| α-type Al₂O₃ | AlCl₃: 3%, CO₂: 5%, HCl: 2%, H₂S: 0.3%, H₂: remainder | 1,050 | 7 |

TABLE III

| | | | | | | | | | | | | Cutting |
|---|---|---|---|---|---|---|---|---|---|---|---|---|
| | | | | | | | Total | Con- | | | | perfor- |
| Sam- | Constitution of the coating | | | | | | thick- | sti- | | Grain | | mance |
| ple | (average layer thickness in μm) | | | | | | ness⁽¹⁾ | tuting | Aspect | diameter⁽³⁾ | Plane of | (Workable |
| No. | 1^{st} layer | 2^{nd} layer | 3^{rd} layer | 4^{th} layer | 5^{th} layer | 6^{th} layer | (μm) | ratio⁽²⁾ | ratio | (μm) | max. TC⁽⁴⁾ | time) |
| 1 | a(2) | — | — | — | — | — | 2.0 | 1.00 | 6.7 | 0.3 | 311 | 20 |
| 2 | b(18) | — | — | — | — | — | 18.0 | 1.00 | 36 | 0.5 | 422 | 25 |
| 3 | TiN(1) | b (15) | — | — | — | — | 16.0 | 0.93 | 30 | 0.5 | 422 | 43 |
| 4 | TiC(2) | TiBN(0.7) | c (7) | TiN(0.5) | — | — | 10.2 | 0.69 | 70 | 0.1 | 422 | 50 |
| 5 | TiN(0.1) | Granular | h (2.6) | TiCNO(0.4) | κ-type | TiN(0.3) | 5.0 | 0.52 | 3.3 | 0.8 | 220 | 30 |
| | | TiCN(0.3) | | | Al₂O₃ (1.3) | | | | | | | |
| 6 | j(15) | ZrC(2) | α-type | TiCO(1) | TiN(2) | — | 25.0 | 0.60 | 10.7 | 1.4 | 220 | 45 |
| | | | Al₂O₃ (5) | | | | | | | | | |
| 7 | TiN(1) | Columnar | k (9) | κ-type | TiN(0.5) | — | 12.5 | 0.72 | 150 | 0.06 | 422 | 40 |
| | | TiCN(0.5) | | Al₂O₃ (1.5) | | | | | | | | |
| 8 | TiN(0.5) | h (4) | TiN(0.5) | α-type | TiCO(0.5) | TiN(0.5) | 7.0 | 0.57 | 5 | 0.8 | 220 | 30 |
| | | | | Al₂O₃ (1) | | | | | | | | |
| 9 | TiN(0.5) | b (7) | TiBN(0.4) | κ-type | TiN(0.5) | — | 9.9 | 0.71 | 14 | 0.5 | 422 | 47 |
| | | | | Al₂O₃ (1.5) | | | | | | | | |
| 10 | TiN(0.5) | a (1) | b (7) | Granular | κ-type | TiN(0.5) | 10.9 | 0.73 | 16 | 0.5 | 422 | 50 |
| | | | | TiCNO(0.4) | Al₂O₃ (1.5) | | | | | | | |
| 11 | a(0.3) | — | — | — | — | — | 0.3 | 1.00 | 1.0 | 0.3 | 311 | 5 |
| 12 | d(18) | — | — | — | — | — | 18.0 | 1.00 | 9 | 2 | 220 | 9 |
| 13 | f(22) | — | — | — | — | — | 22.0 | 1.00 | 22 | 1 | 111 | 10 |
| 14 | TiC(8) | TiBN(8) | e (15) | TiN(3) | — | — | 34.0 | 0.44 | 18.8 | 0.8 | 422 | 12 |
| 15 | TiC(2) | TiBN(0.7) | g (7) | TiN(0.5) | — | — | 10.2 | 0.69 | 14 | 0.5 | 200 | 7 |
| 16 | TiC(2) | TiN(1) | a (1) | TiN(1) | TiC(2) | — | 7.0 | 0.14 | 3.3 | 0.3 | 311 | 8 |
| 17 | TiN(0.5) | i (4) | TiN(0.5) | α-type | TiCO(0.5) | TiN(0.5) | 7.0 | 0.57 | 5.7 | 0.7 | 200 | 9 |
| | | | | Al₂O₃ (1) | | | | | | | | |
| 18 | TiC(2) | TiBN(0.7) | l (7) | TiN(0.5) | — | — | 10.2 | 0.69 | 233 | 0.03 | 422 | 7 |
| 19 | Granular | — | — | — | — | — | 18.0 | — | — | — | — | 0.5 |
| | TiCN(18) | | | | | | | | | | | |
| 20 | TiN(1) | Columnar | κ-type | TiN(0.5) | — | — | 13.0 | — | — | — | — | 1 |
| | | TiCN(10) | Al₂O₃ (1.5) | | | | | | | | | |
| 21 | TiN(1) | ZrC(7) | α-type | TiCO(5) | TiN(1) | — | 19.0 | — | — | — | — | 0.8 |
| | | | Al₂O₃ (5) | | | | | | | | | |

⁽¹⁾Average total thickness of the coating
⁽²⁾Ratio of the average layer thickness of the first compound layer to the average total thickness of the coating
⁽³⁾Average diameter of the crystal grains
⁽⁴⁾Plane at which the maximum orientational tissue coefficient of the first compound layer lies

In this example, Samples 1, 2, 11, 12, and 13 were produced by changing the surface roughness of the substrate from 0.05 μm to 1.5 μm. Similarly, Samples 3 to 10 and 14 to 18 were produced by changing the surface roughness of the member immediately underneath the first compound layer, whether it is the substrate or another compound layer, from 0.01 μm to 1.0 μm. These changes changed the aspect ratio and the plane at wich the maximum orientational tissue coefficient lies. All of the first compound layers made of oxycarbonitride had a columnar structure.

The coated cutting tools shown in Table III were subjected to a cutting test under the conditions described below to evaluate the cutting performance. The cutting performance was evaluated by the workable time until the tool reaches the end of its useful life. The end of the tool life was judged by the moment when the tool's substrate was fractured or when the width of a flank wear exceeded 0.3 mm. The test results are also shown in Table III.

(Cutting Conditions)

Cutting method: continuous cutting

Workpiece: JIS SCM435, round bar

Cutting speed: 400 m/min

Feed: 0.30 mm/rev.

Depth of cut: 1.8 mm

Cutting time: workable time until the tool reaches the end of its useful life

Cutting fluid: not used

As can be seen from Table III, Samples 1 to 10, whose first compound layers satisfied the following conditions, had a considerably longer tool life than that of Samples 19 to 21, which were produced under the conventional film-forming condition:

(a) x>y>z and x+y+z=1 0.74>x>0.35, 0.45>y>0.20, and 0.30>z>0.06;

(b) the average layer thickness is at least 0.5 μm and at most 20 μm, and the thickness constitutes at least one-half the average total thickness of the coating;

(c) the layer has a columnar structure; and

(d) in the crystal structure, the largest orientational texture coefficient lies at one of the (220), (311), and (422) planes.

The test results also showed that Samples 1 to 10 had a longer tool life than that of Samples 11 to 18, which failed to satisfy the conditions (a) to (d) listed above. The present inventors believe that the above result was obtained because Samples 1 to 10 had the first compound layer that satisfied the conditions (a) to (d) above and therefore had an improved wear resistance, in particular. Consequently, the coated cutting tool of the present invention has excellent wear resistance even under the working condition that the cutting part is subjected to high temperatures resulting from high-speed, high-efficiency machining or dry cutting. The tool also has an excellent chipping resistance and breakage resistance in the cutting part under the same condition. As a result, the tool has an increased tool life.

In particular, Sample 2, which satisfied the condition 0.62>x>0.40, 0.40>y>0.25, and 0.20>z>0.13, had a better wear resistance than that of Sample 1, which satisfied the condition (a). Samples 3 to 10, which had the second compound layer in addition to the first compound layer, had more outstanding wear resistance, showing a longer tool life. Of Samples 3 to 10, the following two samples had particularly noticeable wear resistance, showing a longer tool life:

Sample 10: it had a titanium nitride layer at the innermost position, the first compound layer composed of two layers having different atomic compositions, and the second compound layer, in this order in succession.

Sample 9: it had a titanium nitride layer at the innermost position, the first compound layer, a titanium boronitride layer, an aluminum oxide layer, and a titanium nitride layer at the outermost position, in this order in succession.

### EXAMPLE 2

The following samples of cutting tools were produced by coating different types of substrates with the same coating used in Sample 9 in Example 1 under the same conditions as in Example 1: Sample 2-1 having a cermet-alloy substrate, Sample 2-2 having a ceramic substrate, and Sample 2-3 having a cBN substrate. The samples were subjected to a cutting test under the conditions described below to evaluate the cutting performance. The cutting performance was evaluated by the same method as used in Example 1. For comparison, Sample 20 in Example 1 was also subjected to the same cutting test to evaluate the cutting performance.

The cermet-alloy substrate of Sample 2-1 was produced by the following process. First, the following material powders were prepared with the indicated weight percentage: 22% TiCN, 5% TaC, 4% NbC, 7% Co, 10% Ni, and TiC constituting the remaining part. The powders were wet-mixed with a ball mill for 10 hours. The mixed powders were dried and formed with a press into a green compact. The green compact had the shape of an indexable insert with chip breakers expressed as ISO SNMMG120408. The green compact was placed in a sintering furnace to be sintered at 1,500° C. in an atmosphere under vacuum for one hour. The sintered body was subjected to a honing treatment to obtain the cermet-alloy substrate.

The ceramic substrate of Sample 2-2 was produced by the following process. First, the following material powders were prepared with the indicated weight percentage: 74% Al₂O₃, 24% ZrO₂, 1% MgO, and 1% CaO. The powders were mixed together with a solvent containing a high-molecule electrolyte and pulverized with a rotary mill for 72 hours. A binder was added to and mixed with the obtained slurry. The mixed slurry was dried and formed with a press into a green compact. The green compact had the shape of an indexable insert expressed as ISO SNMG120408. The green compact was sintered at 1,600° C. in the atmosphere under atmospheric pressure for 260 minutes. The sintered body was subjected to a hot isostatic pressing (HIP) treatment in an inert gas at 1,550° C. and at 150 MPa for two hours to obtain a ceramic body. The ceramic body was treated by honing to obtain the ceramic substrate.

The cBN substrate of Sample 2-3 was produced by the following process. First, the following material powders were prepared: a binder powder composed of 40 wt. % TiN and 10 wt. % Al and a 50 wt. % cBN powder having an average particle diameter of 2.5 μm. The powders were mixed by using a pot and balls both made of cemented carbide. The mixed powders were packed in a cemented-carbide container to be sintered at a temperature of 1,400° C. and at a pressure of 5 GPa for 60 minutes. The cBN sintered body was processed to obtain an indexable insert for cutting use having the shape Of ISO SNGA120408.

(Cutting Conditions)

Cutting method: interrupted cutting

Workpiece: JIS SCM435, round bar with two grooves

Cutting speed: 300 m/min

Feed: 0.4 mm/rev.

Depth of cut: 2.5 mm

Cutting time: workable time until the tool reaches the end of its useful life

Cutting fluid: not used

The cutting test result showed that whereas Sample 20 had a workable time of 0.5 minute, Samples 2-1 to 2-3 had a workable time of more than 10 minutes. The result confirmed that the samples of this example had excellent wear resistance even under harsher cutting conditions, such as high-speed, high-rate feeding interrupted cutting, showing that they have an increased tool life.

What is claimed is:

1. A coated cutting tool comprising a hard-alloy substrate and a coating formed over the substrate, the coating comprising a first compound layer that:
(a) comprises at least one layer; and
(b) has an average layer thickness of at least 0.5 μm and at most 20 μm, the thickness constituting at least one-half the average total thickness of the coating;
the at least one layer being made of oxycarbonitride of a metal belonging to one of the IVa, Va, and VIa groups in the periodic table;
the at least one layer having:
(c) atomic ratios of carbon, nitrogen, and oxygen, expressed as x, y, and z, respectively, that satisfy the following formulae:
x>y>z and x+y+z=1
0.74>x>0.35, 0.45>y>0.20, and 0.30>z>0.06;
(d) a columnar structure; and
(e) in the crystal structure, the largest orientational texture coefficient that lies in one of the orientational texture coefficients TC(220), TC(311), and TC(422) at the (220), (311), and (422) planes, respectively.

2. A coated cutting tool as defined by claim 1, wherein the at least one layer has atomic ratios that satisfy the following formulae:
0.62>x>0.40, 0.40>y>0.25, and 0.20>z>0.13.

3. A coated cutting tool as defined by claim 1, wherein:
(a) the columnar structure has an aspect ratio of at least three; and
(b) the crystal has an average grain diameter of at least 0.05 μm and at most 1.5 μm.

4. A coated cutting tool as defined by claim 1, wherein:
(a) the coating further comprises a second compound layer comprising at least one layer made of a material selected from the group consisting of:
(a1) carbide, nitride, carbonitride, boride, boronitride, borocarbonitride, oxyboronitride, oxide, oxycarbide, oxynitride, and oxycarbonitride (except the oxycarbonitride having the same atomic ratios as those of the first compound layer) of the metals belonging to the IVa, Va, and VIa groups in the periodic table;
(a2) aluminum oxide; and
(a3) a solid solution of these; and
(b) the coating has an average total thickness of at least 1.0 μm and at most 30 μm.

5. A coated cutting tool as defined by claim 4, wherein the coating comprises:
(a) a titanium nitride layer formed as the innermost layer over the surface of the hard-alloy substrate;
(b) the first compound layer comprising at least two layers formed at the outside of the titanium nitride layer; and
(c) the second compound layer comprising at least one layer formed at the outside of the first compound layer.

6. A coated cutting tool as defined by claim 1, wherein the coating further comprises:
(a) a titanium compound layer that:
(a1) comprises at least one layer made of a material selected from the group consisting of titanium boronitride and titanium oxyboronitride; and
(a2) is formed immediately over the first compound layer;
(b) an oxide layer that:
(b1) comprises at least one layer made of a material selected from the group consisting of aluminum oxide, zirconium oxide, and a solid solution of these; and
(b2) is formed immediately over the titanium compound layer; and
(c) a compound layer that:
(c1) is made of a material selected from the group consisting of carbide, nitride, carbonitride, oxycarbide, oxynitride, and oxycarbonitride (except the oxycarbonitride having the same atomic ratios as those of the first compound layer) of the metals belonging to the IVa, Va, and VIa groups in the periodic table; and
(c2) is formed at the outermost position of the coating.

7. A coated cutting tool as defined by claim 4, wherein the coating further comprises:
(a) a titanium compound layer that:
(a1) comprises at least one layer made of a material selected from the group consisting of titanium boronitride and titanium oxyboronitride, and
(a2) is formed immediately over the first compound layer;
(b) an oxide layer that:
(b1) comprises at least one layer made of a material selected from the group consisting of aluminum oxide, zirconium oxide, and a solid solution of these; and
(b2) is formed immediately over the titanium compound layer; and
(c) a compound layer that:
(c1) is made of a material selected from the group consisting of carbide, nitride, carbonitride, oxycarbide, oxynitride, and oxycarbonitride (except the oxycarbonitride having the same atomic ratios as those of the first compound layer) of the metals belonging to the IVa, Va, and VIa groups in the periodic table; and
(c2) is formed at the outermost position of the coating.

8. A coated cutting tool as defined by claim 5, wherein the coating further comprises:
(a) a titanium compound layer that:
(a1) comprises at least one layer made of a material selected from the group consisting of titanium boronitride and titanium oxyboronitride; and
(a2) is formed immediately over the first compound layer;
(b) an oxide layer that:
(b1) comprises at least one layer made of a material selected from the group consisting of aluminum oxide, zirconium oxide, and a solid solution of these; and
(b2) is formed immediately over the titanium compound layer; and
(c) a compound layer that:
(c1) is made of a material selected from the group consisting of carbide, nitride, carbonitride, oxycarbide, oxynitride, and oxycarbonitride (except the oxycarbonitride having the same atomic ratios as those of the first compound layer) of the metals belonging to the IVa, Va, and VIa groups in the periodic table; and
(c2) is formed at the outermost position of the coating.
